(19) United States
(12) Patent Application Publication
(10) Pub. No.: US 2010/0320831 A1
(43) Pub. Date: Dec. 23, 2010

(54) COMPOSITE RIM

(76) Inventor: Rystar SU, Taichung City (TW)

Correspondence Address: Dr. BANGER SHIA;Patent Office of Bang Shia, 102 Lindencrest Ct, Sugar Land, TX, 77479-5201, US

(21) Appl. No.: 12/489,330

(22) Filed: Jun. 22, 2009

(51) Int. Cl. B60B 25/00

(52) U.S. Cl. 301/95.103

(57) ABSTRACT

A composite rim of the present invention includes a metallic outer sub-rim and a carbon composite material based inner sub-rim. The outer sub-rim is an integrated structure and has an inner surface, on which the inner sub-rim is attached. Thereby, the material consumption is reduced and the mechanical strength is maintained in the meanwhile.

### BACKGROUND OF THE INVENTION

1. Field of the Invention

The present invention relates to a wheel rim, and more particularly to a composite rim.

2. Description of the Prior Art

The rims of a vehicle function as a device to bear the loading and as a device to connect the tires. That makes the rims fundamental and critical components of a vehicle. Thus the manufacturing process and the material are the key factors in order to achieve the desired product weight and mechanical strength.

Conventional rims are manufactured by bending metallic bars. After the metallic bar is bent to be in a substantially circular shape, two terminals of the bar are then jointed together by gluing, welding, an extra bolt element or other joint elements. Thereafter, the metallic circle undergoes a surface treatment and the carbon composite material is then attached on an inner surface of the metallic circle to form a composite rim. The disadvantage of this manufacturing process is that the structure is not continuous at the joint of the metallic circle and thus forms a seam. When the brake rubs against the metallic circle's braking surface, the seam may cause damages to both the brake and the rim itself.

The U.S. Pat. No. 6,991,298 provides a seamless composite rim, in which the rim is manufactured by jointing two terminals of a metallic bar to form a metallic circle with two continuous seamless braking surfaces, in order to overcome the damages caused by seams. Although the braking surfaces are continuous and seamless, the metallic circle itself is, however, not continuous in structure. That is to say, even the metallic circle of '298 looks continuous in a part of its appearance, it is essentially discontinuous in the whole structure and some pores remain in the interior of the joint. Thus this kind of rim will come up with a problem that the structural discontinuousness is prone to be broken by both the internal stress, which may be caused by elevated temperature, and the external force, such as heavy loading or an accidental bump. Moreover, when the joint material is different from the material of the metallic circle, the strain intensities of the joint and the circle are also diverged from each other. Therefore, as the metallic circle is deformed or twisted, either temporarily or permanently, the strain intensity difference is very possibly leading to the breaking-up of the attached carbon composite material since the carbon composite material is almost inextensible and brittle.

### SUMMARY OF THE INVENTION

Based on the mechanical and materiological research, we found that the internal stress will concentrate on the structural discontinuous point, and the stress usually exceed the capacity the discontinuous point can bear, which leads to structural damage. Because the strain directly depends from the material, an object is prone to be twisted once the material distribution is un-uniform and discontinuous. Due to the structural and material discontinuousness which can be seen in the conventional composite rims, Applicant is therefore dedicated to overcome such disadvantages.

The main object of the present invention is to provide a vehicle rim with sufficient mechanical strength and lightened weight.

To achieve the above object, a composite rim of the present invention includes a metallic outer sub-rim and a carbon composite material based inner sub-rim. The outer sub-rim is integrally formed and has an inner surface, on which the inner sub-rim is attached.

Accordingly, the outer sub-rim of the present invention is completely seamless, such that the damage caused by the structural and material discontinuousness, which easily leads to stress concentration, is eventually avoided. As such, the weight lightening and mechanical strength of the composite rim can be both realized.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a pictorial drawing in accordance with a preferred embodiment of the present invention;

FIG. 2 is a profile in accordance with a preferred embodiment of the present invention;

FIG. 3 is a side view in accordance with another preferred embodiment of the present invention;

FIG. 4 is a profile in accordance with another preferred embodiment of the present invention;

FIG. 5 is a profile in accordance with yet another preferred embodiment of the present invention.

### DETAILED DESCRIPTION OF THE PREFERRED EMBODIMENTS

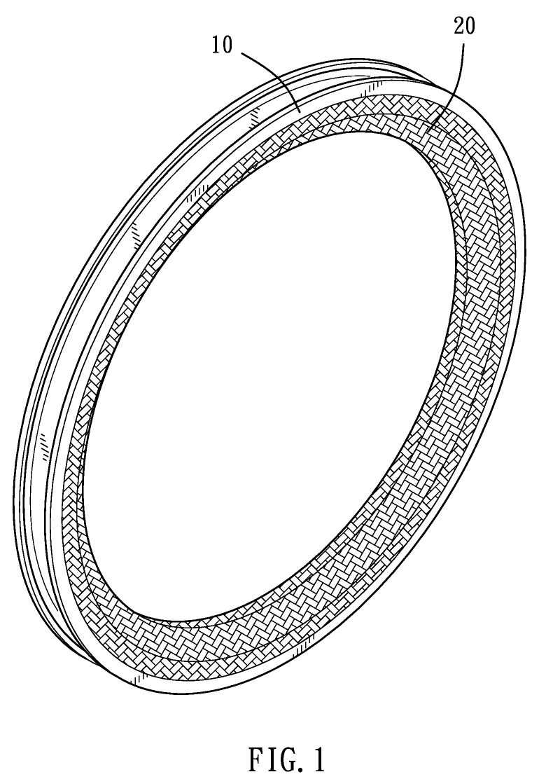

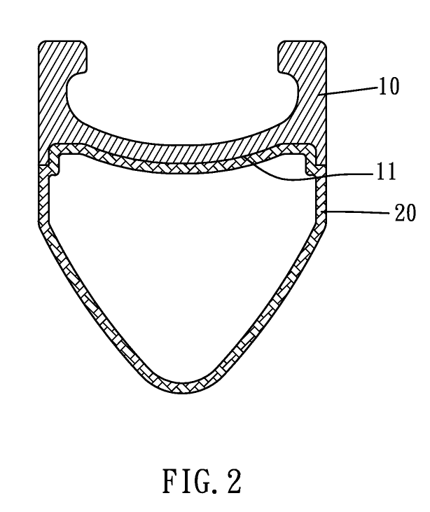

Please refer to FIG. 1 and FIG. 2. A composite rim of the present invention includes an outer sub-rim 10 and an inner sub-rim 20. The outer sub-rim 10 is substantially made of a metallic material, and it is integrally formed. The outer sub-rim 10 has an inner surface 11, on which the inner sub-rim 20 is attached. The inner sub-rim 20 is made of a carbon composite material.

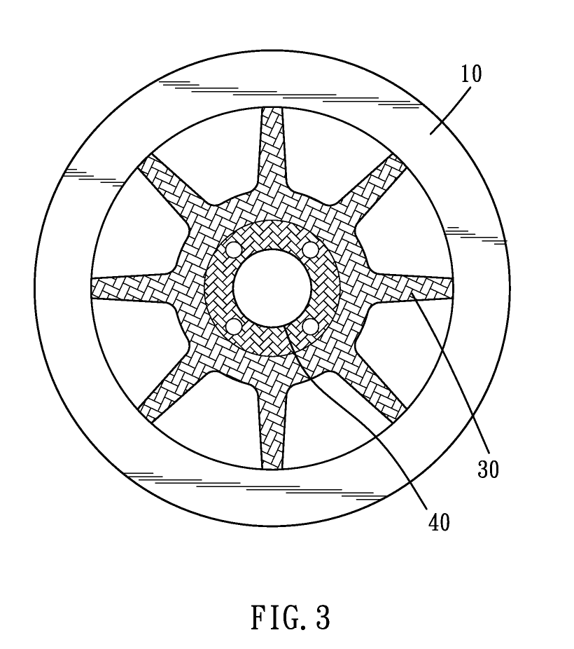

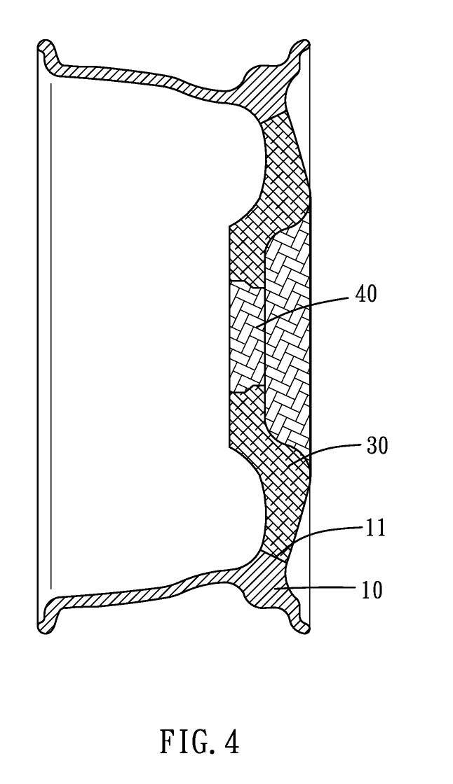

Please refer to FIG. 3 and FIG. 4 for another embodiment of the present invention. A composite rim of the present embodiment includes an outer sub-rim 10 which is integrally formed. The outer sub-rim 10 is substantially made of a metallic material. The outer sub-rim 10 has an inner surface 11, on which a spider portion 30 is mounted. The spider portion 30 is substantially made of a carbon composite material. The spider portion 30 has an axle bore 40 located at a center of the outer sub-rim 10 for the composite rim to be installed on a vehicle.

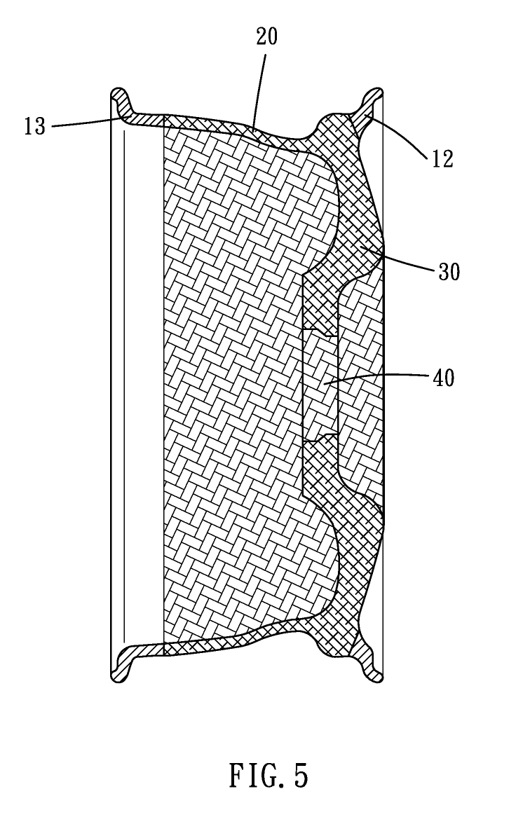

Refer to FIG. 5 for yet another embodiment of the present invention. A composite rim of the present embodiment includes a front sub-rim 12, a rear sub-rim 13, an inner sub-rim 20 and a spider portion 30. The front and rear sub-rims 12, 13 are respectively formed into integrated structures and are substantially made of a metallic material. The inner sub-rim 20 has two side walls, on which the front sub-rim 12 and the rear sub-rim 13 are respectively attached. The spider portion 30 is mounted on the inner sub-rim 20. Both the inner sub-rim 20 and the spider portion 30 are respectively made of a carbon composite material. The spider portion 30 has an axle bore 40 located at a center of the inner sub-rim 20.

The metallic material of the sub-rims is selected from the group consisting of aluminum alloy, titanium alloy and the like. Among the foregoing, the aluminum alloy is less expensive and has better mechanical performance. Also, the aluminum can be easily finished. The titanium alloy has better weight/strength ratio, and its coefficient of thermal expansion is similar to that of the carbon composite material, so that it can be more tightly attached with the inner sub-rim. As such, the composite rim achieves better mechanical performance with lightened weight.

In the present invention, the metallic sub-rims can be manufactured by an integration process such as casting, stamping, press forging and a combination thereof or the like process. The casting process is a mature skill with lower manufacturing difficulty. The stamping process has the advantages that its technique requirement is low and the mechanical characteristic in the surface is enhanced. The press forging process is highly technique required, but the mechanical characteristic is further enhanced. As such, the present invention can realize both the weight lightening and mechanical strength of the composite rim. Also, the attachment between the metallic sub-rims and the carbon composite material based sub-rims is more stable and tightened.

What is claimed is:

1. A composite rim, comprising an outer sub-rim and an inner sub-rim, the outer sub-rim being integrally formed and substantially made of a metallic material, the outer sub-rim having an inner surface, on which the inner sub-rim is attached, the inner sub-rim being substantially made of a carbon composite material.

2. The composite rim of claim 1, wherein the outer sub-rim is integrally formed by a process selected from a group consisting of casting, stamping, press forging and a combination thereof.

3. The composite rim of claim 2, wherein the metallic material is selected from a group consisting of aluminum alloy and titanium alloy.

4. A composite rim, comprising an outer sub-rim, the outer sub-rim being integrally formed and substantially made of a metallic material, the outer sub-rim having an inner surface, on which a spider portion is mounted, the spider portion being substantially made of a carbon composite material, the spider portion having an axle bore located at a center of the outer sub-rim.

5. The composite rim of claim 4, wherein the outer sub-rim is integrally formed by a process selected from a group consisting of casting, stamping, press forging and a combination thereof.

6. The composite rim of claim 5, wherein the metallic material is selected from a group consisting of aluminum alloy and titanium alloy.

7. A composite rim, comprising a front sub-rim, a rear sub-rim, an inner sub-rim and a spider portion, the front sub-rim and the rear sub-rim being respectively substantially made of a metallic material, the front sub-rim and the rear sub-rim being respectively integrally formed, the inner sub-rim having two side walls, on which the front sub-rim and the rear sub-rim are respectively attached, the spider portion being mounted on the inner sub-rim, both the inner sub-rim and the spider portion being respectively made of a carbon composite material, the spider portion having an axle bore located at a center of the inner sub-rim.

8. The composite rim of claim 7, wherein the front and rear sub-rims are respectively integrally formed by a process selected from a group consisting of casting, stamping, press forging and a combination thereof.

9. The composite rim of claim 8, wherein the metallic material is selected from a group consisting of aluminum alloy and titanium alloy.
